(19) United States
(12) Patent Application Publication
(10) Pub. No.: US 2007/0268319 A1
(43) Pub. Date: Nov. 22, 2007

(54) Image processing apparatus and image processing method, digital information storage medium, and reversible display recording medium

(76) Inventors: Tadafumi Tatewaki, Sunto-gun (JP); Hideo Sakurai, Sunto-gun (JP); Yukio Ide, Atami-shi (JP)

Correspondence Address: Christopher C. Dunham;c/o Cooper & Dunham LLP, 1185 Ave. of the Americas, New York, NY, 10036, US

(21) Appl. No.: 11/803,494

(22) Filed: May 14, 2007

(30) Foreign Application Priority Data
May 19, 2006 (JP) 2006-140345

(51) Int. Cl. B41J 2/01

(52) U.S. Cl. 347/1

(57) ABSTRACT

To provide an image processing apparatus which preferably obtains information concerning a record condition or erasure condition varying by each reversible display recording medium. The image processing apparatus which forms an image on the reversible display recording medium containing the record condition or erasure condition varying by each manufacturer, model number, version, or lot number, in which the image processing apparatus containing a condition information obtaining unit configured to obtain condition information concerning the record condition or erasure condition of the reversible display recording medium from the reversible display recording medium.

### BACKGROUND OF THE INVENTION

1. Field of the Invention

The present invention relates to an image processing apparatus, an image processing method, a digital information storage medium, and a reversible display recording medium.

2. Description of the Related Art

Conventionally, various reversible display recording mediums have been proposed and advanced in practical use owing to the much-discussed problems of waste and deforestation in recent years in the background. For example, Japanese Patent (JP-B) No. 3557076 discloses a reversible thermosensitive coloring composition, in which a phenol compound having a long chain aliphatic hydrocarbon group as a developer and a leuco dye as a coloring agent are combined, is colored and erased by heat and cool condition. JP-B No. 3557076 further discloses a technique of a reversible thermosensitive display recording medium, in which a recording layer containing the reversible thermosensitive coloring composition is disposed on a support. The technique disclosed in JP-B No. 3557076 enables to maintain coloring condition and erasing condition stably at a room temperature and repeatedly color-develop and erase.

Various reversible display recording mediums such as a reversible thermosensitive display recording medium disclosed in JP-B No. 3557076 are needed to perform the processing of each of the display record and display erasure under the condition depending on the respective properties of the medium. Then, in the image processing apparatus which performs display record or display erasure in the reversible display recording medium the condition must be set depending on the property of each medium.

However, the property of the reversible display recording medium greatly differs depending on change of properties by modifying a reversible display recording medium by a manufacturer, or a lot in the production, as well as kinds and preparation. Because the processing depending on each reversible display recording medium is needed, the image processing apparatus which performs display record and display erasure is needed to set the existing property of the reversible display recording medium at the time of production, and additionally set according to the properties of the reversible display recording medium when the one having a new property by modification is used due to the production of the image processing apparatus.

These settings for every production lot of the reversible display recording medium to be used is a significant burden to a operator or supervisor of the image processing apparatus. It has not been considered that the demand of a record and erasure controlling device such as an image forming apparatus, which automatically or semi-automatically obtains and sets the condition depending on a property of each reversible display recording medium to be used.

Japanese Patent Application Laid-Open (JP-A) No. 2005-259108 discloses a technique of document management system that tracks and keeps security condition of each document. In the technique a print ID is embedded in a document to be printed by an image forming apparatus, and a server connected through a network to the image forming apparatus controls the print ID. A profile which links the document printed beforehand as a derivative source to an obtained electronic document or newly printed document is generated, when the printed document is obtained as the electronic document or printed again. However, the technique disclosed in JP-A No. 2005-259108 is a technique corresponding to the contents of display record, and the management of the medium used for the display record is not considered.

Moreover, recently, display record and display erase to the reversible display recording medium are needed to be processed at high speed with the demand for speeding up of processing in an image processing apparatus. As the technique disclosed in JP-A No. 2005-259108, it is not easy to shorten the time from an instruction of executing the process by an operator to the completion of the display record or display erasure due to the access to a security server each time of executing display record.

### BRIEF SUMMARY OF THE INVENTION

The object of the present invention is to provide an image processing apparatus which preferably obtains information of a record condition or erasure condition varying by each reversible display recording medium.

To achieve the object of the invention, the image processing apparatus of the invention adopts the following configuration.

The image processing apparatus of the present invention is an image processing apparatus contains a condition information obtaining unit configured to obtain condition information concerning a record condition or erasure condition of a reversible display recording medium from the reversible display recording medium, in which the image processing apparatus forms an image on the reversible display recording medium,

Thus, it is possible to provide the image processing apparatus which preferably obtains the condition information varying by each reversible display recording medium from the reversible display recording medium.

The image processing apparatus of the present invention further contains an image forming unit configured to form an image on the reversible display recording medium on the basis of the record condition.

Thus, it is possible to provide the image processing apparatus which forms an image on the reversible display recording medium on the basis of the record condition obtained from the reversible display recording medium.

The image processing apparatus of the present invention further contains an image erasing unit configured to erase the image formed on the reversible display recording medium on the basis of the erasure condition.

Thus, it is possible to provide the image processing apparatus which can erase the image formed on the reversible display recording medium on the basis of the erasure condition obtained from the reversible display recording medium.

The reversible display recording medium processed by the image processing apparatus of the present invention contains a digital information storage medium which is integrated with the reversible display recording medium, and the condition information obtaining unit obtains the condition information from the digital information storage medium.

Thus, it is possible to provide the image processing apparatus which obtains the condition information of the reversible display recording medium from the digital information storage medium integrated with the reversible display recording medium.

A code of the condition information is formed on the reversible display recording medium which is processed by the image processing apparatus of the present invention, and the condition information obtaining unit contains a code obtaining unit configured to obtain the code of the condition information, and a condition information decoding unit configured to decode the code of the condition information.

Thus, it is possible to provide the image processing apparatus which obtains the condition information by obtaining the code formed on the reversible display recording medium.

The image processing apparatus of the present invention further contains a condition information holding unit configured to hold the condition information obtained by the condition information decoding unit, and a condition encoding unit configured to encode the condition information.

Thus, it is possible to provide the image processing apparatus which encodes the condition information obtained by the image processing apparatus so as to form a code on the reversible display recording medium.

The image processing apparatus of the present invention further contains a record or erasure condition holding unit configured to hold the record condition or erasure condition, in which the condition information obtaining unit obtains the record condition or erasure condition from the record or erasure condition holding unit according to medium information, when the condition information contains the medium information corresponding to a model number or lot number of the reversible display recording medium.

Thus, it is possible to provide the image processing apparatus which obtains the condition corresponding to the model number or lot number of the reversible display recording medium from the record condition or erasure condition held by the image processing apparatus.

The image processing apparatus of the present invention further contains a communicating unit configured to communicate through a network, a record or erasure condition obtaining unit configured to obtain a record condition or erasure condition from a server connected through the network so as to store the record condition or erasure condition in the record or erasure condition holding unit.

Thus, it is possible to provide an image processing apparatus which preferably obtains and updates the record condition or erasure condition stored in the record or erasure condition holding unit.

The image processing method of the present invention and contains a step of obtaining condition information concerning a record condition or erasure condition of a reversible display recording medium from the reversible display recording medium in which the image processing method forms an image on the reversible display recording medium.

The image processing method of the present invention contains a step of forming the image on the reversible display recording medium on the basis of the record condition. The image processing method of the present invention further contains a step of erasing the image formed on the reversible display recording medium on the basis of the erasure condition.

In the image processing method of the present invention, the condition information is obtained from a digital information storage medium integrated with the reversible display recording medium in the step of obtaining the condition information.

The image processing method of the present invention contains the step of obtaining the condition information containing a step of obtaining a code of the condition information formed on the reversible display recording medium, and a step of decoding the code of the condition information.

The image processing method of the present invention further contains a step of holding the condition information obtained in the step of decoding the condition information, a step of encoding the condition information.

The image processing method of the present invention further contains a step of holding the record condition or erasure condition, in which the record or erasure condition is obtained from the step of holding the record or erasure condition according to medium information in the step of obtaining the condition information, when the condition information contains the medium information corresponding to a model number or lot number of the reversible display recording medium.

The image processing method of the present invention further contains a step of obtaining the record condition or erasure condition by a communicating unit configured to communicate through a network from a server which is connected through the network, in which the record condition or erasure condition obtained in the step of obtaining the record or erasure condition is held in the step of holding the record or erasure condition.

A digital information storage medium of the present invention integrated with the reversible display recording medium, in which the digital information storage medium is configured to hold the condition information concerning the record condition or erasure condition of the reversible display recording medium.

The reversible display recording medium of the present invention contains a digital information storage medium which is integrated with the reversible display recording medium, in which the reversible display recording medium can display-record and display-erase, and condition information concerning a display record and display erasure is stored in the digital information storage medium.

The reversible display recording medium of the present invention contains a code of condition information concerning a display record and display erasure, wherein the code contains an irreversible coloring layer and is formed on the reversible display recording medium which can display-record and display-erase.

It is possible to provide the image processing apparatus of the present invention which preferably obtains the information of record condition or erasure condition varying by each reversible display recording medium.

### BRIEF DESCRIPTION OF THE SEVERAL VIEWS OF THE DRAWINGS

FIG. 1 schematically shows an example of the color developing-reducing property in the reversible display recording medium of the present invention.

FIG. 2 schematically shows an example of an RF-ID tag.

FIG. 3 schematically shows an example of a configuration, in which an RF-ID tag is affixed to the side of a back layer of the reversible thermosensitive display recording medium.

FIGS. 4A and 4B schematically show an example of a rewritable sheet of industrial use (reversible thermosensitive display recording medium).

FIG. 5 schematically exemplifies how to use the rewritable sheet of industrial use (reversible thermosensitive display recording medium).

FIGS. 6A and 6B schematically show examples of embodiments, in which the reversible display recording label and a substrate sheet are bonded in a thermo-compression process.

FIGS. 7A and 7B show schematic cross-sectional views of examples of layer constructions of the reversible display recording mediums of the present invention.

FIG. 8A schematically shows an example of a front side of the reversible display recording medium, which is formed into a card shape. FIG. 8B schematically shows an example of a back side of FIG. 8A.

FIG. 9A schematically shows an another example of the reversible display recording medium, which is formed into a card shape. FIG. 9B schematically shows an IC chip to be accommodated into the depression part for the IC chip.

FIG. 10A schematically shows an example of a block diagram of an integrated circuit. FIG. 10B schematically shows that a RAM contains a plurality of storage areas.

FIGS. 11A, 11B, and 11C schematically show examples of image forming apparatuses used for the image processing method of the present invention.

FIG. 12 schematically shows an example of an image forming apparatus, in which an image is erased by a ceramic heater, and an image is formed by a thermal head respectively.

FIG. 13 shows another example of an image forming apparatus of the present invention.

FIG. 14 shows an example of a coloring sensitivity curve of the reversible display recording medium of the present invention.

FIG. 15 shows an example of an erasing sensitivity curve of the reversible display recording medium of the present invention.

FIG. 16 illustrates an example of a function and configuration of the image forming apparatus of the present invention.

FIG. 17 shows a flow chart of an example of processing of erasing and forming an image according to the condition information obtained from a digital information storage medium.

FIG. 18 shows a flow chart of an example of processing of erasing and forming an image by obtaining a code formed on the reversible display recording medium.

FIG. 19 shows a flow chart of an example of processing of erasing and forming an image by obtaining a record condition and erasure condition according to the condition information obtained from the digital information storage medium.

### DESCRIPTION OF THE PREFERRED EMBODIMENTS

“Reversible display recording medium” which is processed by the image processing apparatus of the present invention will be explained hereinbelow.

For the reversible recording material used for the reversible display recording medium capable of reversibly display-recording and display-erasing information, materials in which color condition change may be mainly used, for example, materials of which color or tone changes by heat, laser, light, electric voltage, or electric current and which show thermochromism, photochromism and electrochromism. Examples of the change of color condition include transmittance, reflectivity, absorption wavelength and scattering coefficient. Record display and record erasure may be performed by one of the changes or the combination of the changes. The reversible recording material will be specifically exemplified hereinbelow, but not limited thereto.

### 1) Examples of the Reversible Recording Materials of which Color or Tone Changes by Heat

Examples thereof include the known reversible display recording mediums in which tone changes by changing energy of heat and laser to be applied: (i) a polymer which takes advantage of physical change; (ii) a dye which takes advantage of chemical change; and (iii) a liquid crystal which takes advantage of the change from cholesteric liquid crystal phase to non-cholesteric liquid crystal phase in a cholesteric liquid crystal compound.

Examples of (i) polymers taking advantage of physical change of transparent or opaque include a layer in which particles of an organic low-molecular material are dispersed in a resin matrix which is disposed on a support.

Examples of (ii) dyes include a combination of gallic acid and phloroglucinol, phenolphthalein, or thymolphthalein as a color developer; homogeneously dissolved composition of a coloring agent, a color developer and a carboxylate is contained in a recording layer; an ascorbic acid derivative as a color developer; a salt of bis(hydroxyphenyl) acetic acid or gallic acid, and a higher aliphatic amine as a color developer; and an electron donating compound having long-chain aliphatic group as a color developer.

Examples of (iii) the liquid crystals include a recording material containing a cholesteric liquid crystal compound or a mixture of a cholesteric liquid crystal compound, which can repeatedly display record in a manner such that a reflecting color can maintain at a room temperature for a prolonged period by rapidly cooling from the condition of the cholesteric liquid crystal and then reverse to the condition of liquid crystal, and a recording material of a thermotropic liquid crystal compound which forms cholesteric liquid crystal phase, in which the thermotropic liquid crystal compound is heated to the temperature where shows isotropic phase or cholesteric liquid crystal phase, and then rapidly cooled at a predetermined cooling rate so as to form cholesteric glass phase which is a solid state of spiral molecular arrangement of the cholesteric liquid crystal phase, in which a heat-sensitive phase exhibiting a selective reflective color from the spiral molecular arrangement is contained.

### 2) Examples of the Reversible Recording Materials of which Color or Tone Changes by Light

The reversible display recording medium changes tone by changing energy of light. For example, the reversible display recording medium in which a mixture of three kinds of photochromic fulgide compounds of yellow, magenta, and cyan in a coloring condition is exposed by a UV lamp so as to color-develop all kinds of the photochromic compound, and then is selectively erased by exposing a visible light of wavelength range corresponding to the maximum absorption wavelength of each color-developed photochromic compound, and a reversible display recording medium containing two or more kinds of sensitive layers disposed on a substrate, in which each layer contains photochromic compounds having different maximum absorption wavelengths and absorption edge wavelengths in a coloring condition, comes in a coloring condition by exposing UV light, and in an erasing condition by exposing a visible light.

The reversible recording material used for the reversible display recording medium processed by the image processing apparatus of the present invention may be provided in a part of or entire surface of the medium, and in one surface or both surfaces of the medium.

The shape, the configuration, the size of the support contained in the reversible display recording medium is not limited, and may be properly selected depending on the application. For, example, the shape may be plate-like; the configuration may be a single layer or a laminated layer; and the size may be properly selected depending on the size of the reversible display recording medium.

The materials of the support in the reversible display recording medium may be an inorganic material or an organic material. Examples of the inorganic materials include glass, quartz, silicon, silicon oxide, aluminum oxide, SiO₂ and metal. Examples of the organic materials include paper, cellulose derivatives, such as triacetyl cellulose, synthetic paper, polyethylene terephthalate, polycarbonate, polystyrene and polymethylmethacrylate. These materials may be used alone or in combination.

For improving the adhesion properties of a coat layer, the support is preferably subjected to surface reforming by means of corona discharge processing, oxidation reaction processing (with chromium oxide and the like), etching processing, adherable processing or anti-static processing. Further, the support is preferably rendered to be white by incorporating white pigment, such as titanium oxide.

The thickness of the support is not limited, and may be properly selected depending on the application. The thickness is preferably 1 μm to 2,000 μm, more preferably 5 μm to 1,000 μm, still more preferably 10 μm to 300 μm, and particularly preferably 15 μm to 200 μm.

“A reversible display recording medium integrated with a digital information storage medium” of the present invention will be explained hereinbelow. The reversible display recording medium of the present invention contains a digital information storage medium which is integrated with the reversible display recording medium, and further contains other members. The reversible display recording medium of the present invention contains a display part which can display record and display erase (hereinafter referred to as “reversible display part”), and a digital information storage medium, in which they are integrated or composite in a sheet or card (hereinafter referred to as “integrated”). The reversible display recording medium of the present invention may be configured to display a part of or all information stored in the digital information storage medium. Thus, a user who sees the sheet, etc. can read the information stored in the digital information storage medium due to the display in the display part. When the information stored in the digital information storage medium is updated, the display of the display part is updated according to the information stored in the digital information storage medium. Thus, it improves the convenience to a user.

The reversible display recording medium integrated with the digital information storage medium of the present invention has the following two embodiments:

(1) A part of the member having the digital information storage medium is directly formed into a support of the reversible display recording medium.

(2) A surface of the support of the reversible display recording medium is bonded on a member having the digital information storage medium, in which the reversible display recording medium has a display part on the support.

In (1) and (2), a digital information storage medium and a reversible display part may be configured to exhibit their own functions, and the configurations are not limited to (1) and (2) as long as their functions are exhibited. For example, the digital information storage medium may be an opposite surface from the surface in which the reversible display part of the reversible display recording medium is disposed (hereinafter referred to as “back layer”), between the support and the reversible recording material, or a part of the reversible display part.

Examples of members having the digital information storage medium include magnetic memories such as a magnetic tape, a magnetic stripe and a magnetic layer, an optical memory, a hologram, and semiconductor memories such as a contact IC memory and noncontact IC memory. For example, a semiconductor memory is preferably used for a sheet-like reversible display recording medium which is larger than a card size. The semiconductor memory contains an IC chip and an antenna connected to the IC chip. As the hologram, a rewritable one is preferable, for example, a rewritable hologram in which interference light is written in a polymer azobenzene liquid crystal film.

“A reversible display recording medium on which a code is formed” of the present invention will be explained hereinbelow. The reversible display recording medium on which a code is formed of the present invention contains a code formed on a part of or entire surface on which the reversible display part is disposed, or a part of or entire surface opposite from the surface on which the reversible display part is disposed. The code formed on the reversible display recording medium may be formed by offset printing or gravure printing, by means of printers such as an inkjet printer, heat transfer printer, sublimation printer or a thermal printer, or by other methods.

The “image processing apparatus” and “image processing method” of the present invention will be explained hereinbelow. The image processing apparatus of the present invention contains an image forming unit configured to form an image, an image erasing unit configured to erase the image, a digital information obtaining unit configured to obtain a digital information and a condition setting unit configured to set a preferable image forming condition or image erasure condition by the obtained digital information, and further contains other units.

An image forming unit contained in the image processing apparatus of the invention is configured to form an image on the reversible thermosensitive display recording medium by heating the reversible display recording medium of the present invention such as a reversible thermosensitive display recording medium. Examples of the image forming units include a thermal head printer and a laser printer. These may be selected depending on the purpose, and used alone or in combination.

An image erasing unit contained in the image processing apparatus of the invention is configured to erase an image formed on the reversible thermosensitive display recording medium by heating the reversible display recording medium of the present invention such as the reversible thermosensitive display recording medium. Examples of the image erasing units include a hot stamp, a ceramic heater, a heat roller, a heat block, warm blow, a thermal head and a laser irradiation device.

By using the ceramic heater, the size of the apparatus can be downsized, the erasure condition may be stabilized and images with good contrast can be obtained. The preset temperature of the ceramic heater is not specifically limited and may be appropriately selected depending on the purpose, or the property of the reversible thermosensitive display recording medium.

The use of the thermal head enables the apparatus to be still more downsized compared to the use of the ceramic heater. In addition, the electric power consumption can be lowered so that an apparatus of a handy type which is driven by a battery can be used. One thermal head serving as the image forming unit and the image erasing unit enables the apparatus to be still further more downsized. In case of performing display record and display erasure by one thermal head, any of a method in which the formed image is erased, and then a new image is formed, and a method in which a control element for the thermal head is changed for each image, the formed image is erased and a new image is formed at once (overwrite system) can be adopted. By the overwrite system, the total time of forming and erasing an image can be reduced.

The image processing apparatus of the invention may further contain a conveying unit configured to convey the reversible display recording medium, and a controlling unit. The conveying unit is not limited as long as the unit is configured to convey the reversible display recording medium and may be properly selected depending on the application. Examples of the conveying unit include a conveying belt, a conveying roller and a combination of conveying belt and conveying roller.

The controlling unit is not limited as long as the unit is configured to control each process performed in the image processing apparatus and may be properly selected depending on the application. Examples of the controlling units include a sequencer and a computer.

According to the image processing method of the present invention, the reversible display recording medium of the present invention such as the reversible thermosensitive display recording medium is heated so as to form and erase an image, and obtain digital information, set a preferable image forming condition or image erasure condition by the obtained digital information, and other processes may be performed.

The embodiments of the invention will be explained with reference to the drawings hereinbelow. In the embodiments, the reversible thermosensitive display recording medium is mainly exemplified. However, the image processing apparatus, image processing method, digital information storage medium, and reversible display recording medium of the present invention are not limited to the embodiments of the reversible thermosensitive display recording medium, and may be the image processing apparatus, printing record display method, digital information storage medium, and reversible display recording medium relating to a reversible display recording medium which contains a composition having color developing-reducing property by a temperature, light, chemical factor, or other factors.

### EXAMPLES

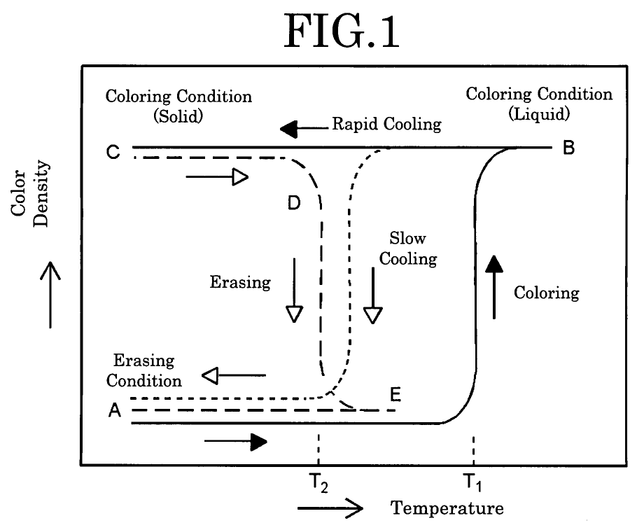

FIG. 1 to FIG. 10B show a reversible display recording medium and a digital information storage medium of the invention.

FIG. 1 shows the color developing-reducing property of an composition contained in a reversible display recording medium of the present invention. FIG. 1 shows the color density property to the temperature of the reversible thermosensitive coloring composition which forms a relatively coloring condition and a relatively erasing condition depending on the heating temperature and/or cooling rate after the heating. When the composition in the initial erasing condition (A) is heated, a color of the medium is developed at the temperature T1 where the medium begins to be molten and comes into the molten and coloring condition (B). When the medium in the molten and coloring condition (B) is cooled rapidly, the temperature of the medium can be lowered to the room temperature while the medium maintains the color-developed condition, thereby the medium comes into the solid coloring condition (C). Whether the medium can come into the solid coloring condition (C) or not depends on the cooling rate from the molten and coloring condition (B) as follows. When the medium in the molten and coloring condition (B) is cooled slowly, the medium comes into the erasing condition (A) or into a condition in which a density of the developed color is relatively lower than a density of the developed color in the solid coloring condition (C). On the other hand, when the medium in the solid coloring condition (C) is heated again, a color of the medium is erased at the temperature T2 which is lower than the above-noted coloring temperature T1 (from D to E), and from here (E), when the medium is cooled, the medium returns into the initial erasing condition (A). Since actual color-developed and color-erased temperatures vary depending on an amount ratio between the coloring agent and color developer, the coloring and erasing temperatures can be properly selected depending on the application of the medium. Further, the color density of the medium in the molten and coloring condition (B) is not always the same as the color density of the medium in the solid coloring condition (C). For example, a composition which is seldom color-developed in the molten and coloring condition (B), but color-developed during the process of cooling rapidly, and consequently to be in the solid coloring condition (C) at a room temperature.

The reversible thermosensitive display recording medium of the invention includes the reversible thermosensitive display recording medium containing a compound having color developing-reducing property corresponding to the various temperature described above, and other reversible display recording media containing a composition having color developing-reducing property by other factors such as temperature, for example, the reversible optical display recording medium.

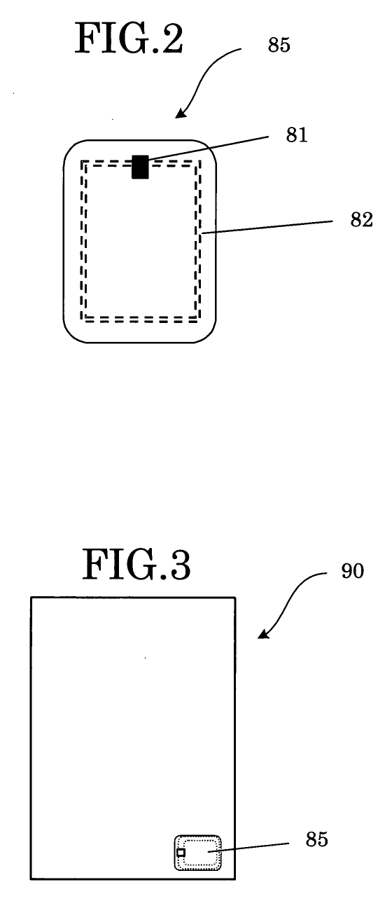

FIG. 2 schematically shows an example of RF-ID tag, which is an example of the digital information storage medium of the present invention. In FIG. 2, the RF-ID tag 85 is composed of a IC chip 81, and an antenna 82 connected to the IC chip 81. The IC chip 81 contains units configured to store, control power supply, transmit and receive, and communications are performed. The data is transmitted and received in a manner that the RF-ID tag 85 is communicated with a reading and writing device (hereinafter referred to as “reader-writer”) by an electric wave. Specifically, the antenna 82 of the RF-ID tag 85 receives electric waves from the reader-writer to cause an electromotive force through an induction due to resonance effect. As a result, the IC chip 81 in the RF-ID tag 85 is activated, the information in the chip is turned into a signal, followed by the dispatch of the signal from the RF-ID tag 85. In the reader-writer, the data is processed by receiving the signal.

FIG. 3 schematically shows an example of the reversible display recording medium of the present invention, in which the RF-ID tag 85 is affixed thereto. As shown in FIG. 3, the RF-ID tag 85 is formed into a label-like or card-like shape. A reversible thermosensitive display recording medium 90 contains a surface of a thermosensitive layer in which display record and display erasure is performed, and a back surface, and the RF-ID tag 85 may be affixed on either the surface of the thermosensitive layer or the back surface. The RF-ID tag 85 may be affixed on the back surface so that the reversible thermosensitive display recording medium 90 and the RF-ID tag 85 are integrated without reducing an area of display record, and a device which performs display record or display erasure in the reversible thermosensitive display recording medium 90, and the reader-writer communicating with the RF-ID tag 85 can be disposed effectively. For the purpose of affixing the RF-ID tag 85 to the reversible thermosensitive display recording medium 90, adhesive agents and tacky agents may be selected depending on the property of the reversible thermosensitive display recording medium 90.

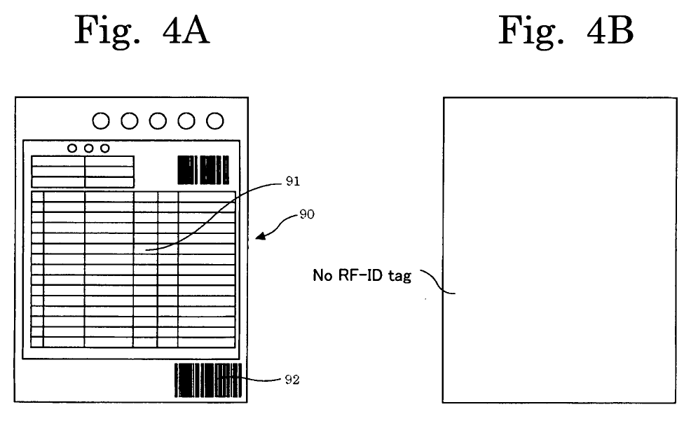

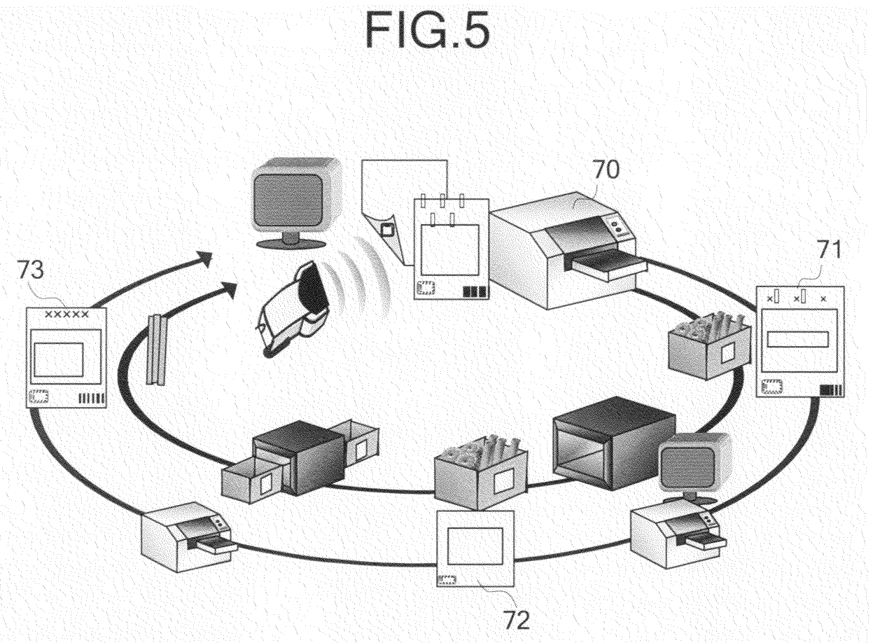

FIGS. 4A and 4B exemplify the reversible thermosensitive display recording medium 90 applied into a rewritable sheet for industrial use. The rewritable sheet for industrial use is the reversible display recording medium which is used for a medium or a form used for process or physical distribution management by alternately recording and erasing in an operation of manufacture, distribution or the like. Here, the reversible thermosensitive display recording medium is exemplified. In FIG. 4A, the reversible thermosensitive display recording medium 90 applied into a rewritable sheet for industrial use contains a display part 91 capable of display-recording and display-erasing, and a code 92 on the surface of the thermosensitive layer.

The display part 91 is an area which is used for a form in the operation of manufacture or distribution, and the code 92 is encoded property information concerning color developing and reducing of the reversible thermosensitive display recording medium 90. The code 92 may be either a one- or two-dimensional bar code. The code 92 may be a code expressed by dots or other codes. The code 92 may be formed on a part of or entire surface of the thermosensitive layer. The code 92 may be formed on the back surface.

The code 92 may contain an irreversible coloring layer and be formed on the reversible thermosensitive display recording medium 90. Thus, the property information can be maintained irrespective of display record and display erasure in the reversible thermosensitive display recording medium 90. The irreversible coloring layer may be formed by offset printing or gravure printing, by means of printers such as an inkjet printer, heat transfer printer, sublimation printer or thermal printer, or by other methods. The code 92 may contain a reversible coloring layer.

The reversible thermosensitive display recording medium 90 in the form of the rewritable sheet for industrial use may contain the RF-ID tag 85 integrated with the reversible thermosensitive display recording medium 90. The RF-ID tag 85 may be affixed on either the surface of the thermosensitive layer or the back surface. The RF-ID tag 85 may be affixed on the back surface so that the reversible thermosensitive display recording medium 90 and the RF-ID tag 85 are integrated without reducing an area of the display part, and a device performing display record or display erasure in the reversible thermosensitive display recording medium 90, and the reader-writer communicating with the RF-ID tag 85 can be disposed effectively.

FIG. 5 schematically exemplifies how to use the rewritable sheets of industrial use of the reversible thermosensitive display recording medium 90 of the present invention in a process or physical distribution management, and the reversible thermosensitive display recording medium 90 contains the RF-ID tag 85 integrated therein. First, in the inspected row material, the information such as a product name and quantity is display-recorded in the reversible thermosensitive display recording medium 90 as an inspection letter 71 and stored in the RF-ID tag 85 by means of a rewritable printer for RFID 70, and attached to a circulating box, etc. and then subjected to inspection. Next, the product name and quantity of the contained raw material is read from the RF-ID tag 85, a process instruction corresponding to the raw material is given, and stored in the RF-ID tag 85 and together with being display-recorded in a display part 91 of the rewritable sheet for industrial use as a working instruction letter 72, and then proceed to the processing step.

In the processing step, the raw material is processed to a product by reading the processing instruction from the RF-ID tag 85. Order information is stored in the RF-ID tag 85, and the order information is display-recorded in the display part 91 of the rewritable sheet for industrial use as an order instruction 73. After the product is shipped, the display part 91 of the rewritable sheet for industrial use is erased, and the product name, quantity, process instruction and order information stored in the RF-ID tag 85 are erased.

In FIG. 5, the information of color developing-reducing property of the reversible thermosensitive display recording medium 90 is recorded in a certain area of the IC chip contained in the RF-ID tag 85, and display record and display erasure are preferably performed by reading the information.

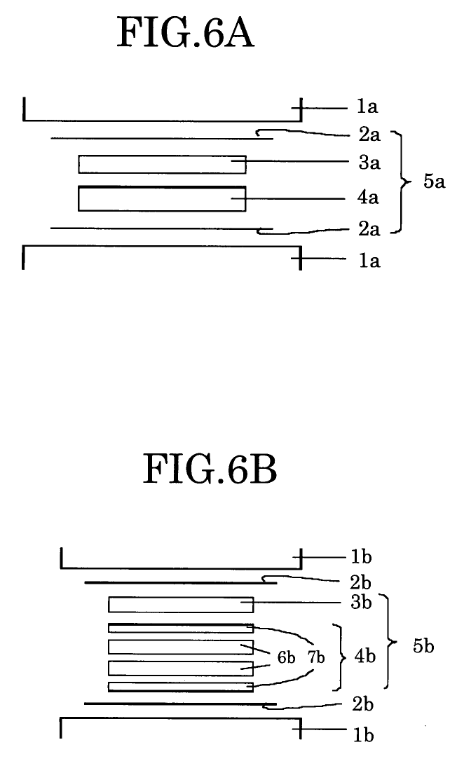

FIGS. 6A and 6B schematically show examples of thermo-compression bonding process of producing the reversible thermosensitive display recording medium of the present invention. In FIG. 6A, a reversible thermosensitive recording label 3a is laminated on a substrate sheet 4a, which is sandwiched by mirror surface plates 2a, and then externally thermo-compression bonded by hot plates 1a to produce a reversible thermosensitive display recording medium 5a. In FIG. 6B, a substrate sheet 4b is composed of core sheets 6b and oversheets 7b. A reversible thermosensitive recording label 3b is laminated on the substrate sheet 4b, which is sandwiched by mirror surface plates 2b, and externally thermo-compression bonded by hot plates 1b to produce a reversible thermosensitive display recording medium 5b in the same manner as in FIG. 6A. The digital information storage medium, for example, the RF-ID tag 85 is integrated with the reversible thermosensitive display recording medium 5a or 5b, in which the RF-ID tag 85 may be thermo-compression bonded by sandwiching between the reversible thermosensitive display recording medium 5a and 5b, the RF-ID tag 85 may be thermo-compression bonded from the surface of the reversible thermosensitive display recording medium or the back surface, or the RF-ID tag 85 may be affixed thereto by an adhesive agent after thermo-compression bonded.

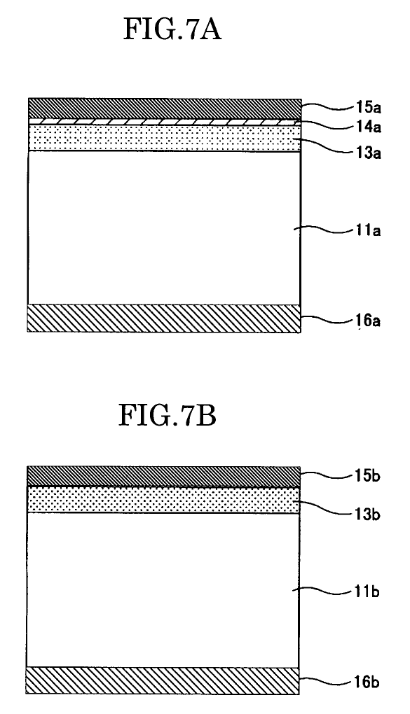

FIGS. 7A and 7B show schematic cross-sectional views of examples of layer constructions of the reversible thermosensitive display recording medium of the present invention, and the reversible thermosensitive display recording medium is a film. In FIG. 7A, a reversible thermosensitive layer 13a, an intermediate layer 14a, and a protective layer 15a are disposed on a support 11a, and on the opposite side thereof a back layer 16a is disposed. In FIG. 7B, a reversible thermosensitive layer 13b, and a protective layer 15b are disposed on a support 11b, and on the opposite side thereof a back layer 16b is disposed. The reversible thermosensitive display recording medium of the aspects as shown in FIGS. 7A and 7B, other aspects, and aspect in a film may be preferably applied to the various rewritable sheets for industrial use as shown in FIGS. 4A and 4B for example.

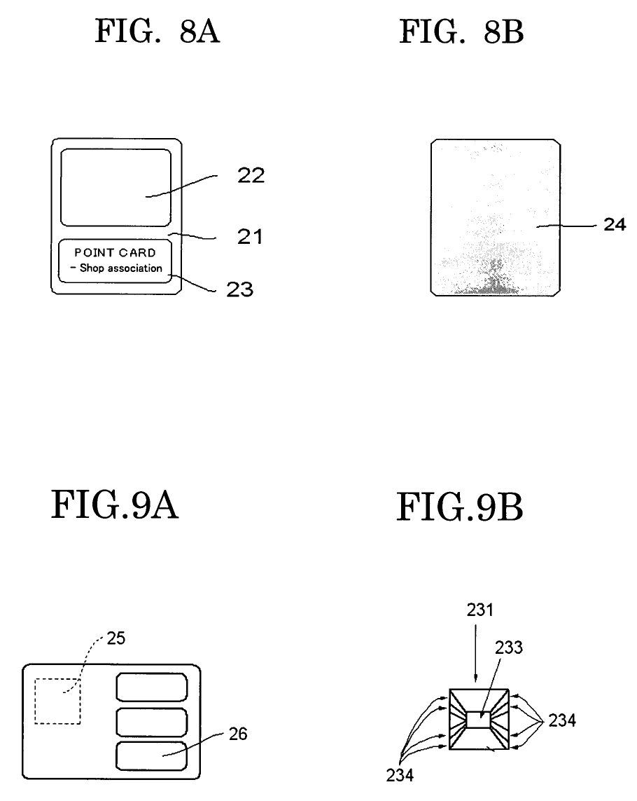

FIGS. 8A and 8B show an example of an embodiment of the reversible thermosensitive display recording medium used as a reversible thermosensitive recording card. FIG. 8A shows a reversible displaying surface (a front side) of the reversible thermosensitive recording card in which a reversible displaying surface 22 and an irreversible displaying surface 23 are disposed on the front side of a reversible thermosensitive recording card 21. FIG. 8B shows the back side of the reversible thermosensitive recording card 21, a magnetic recording part is disposed on the entire back side, and a back layer 24 on the magnetic recording part.

FIGS. 9A and 9B show an example of another embodiment of the reversible thermosensitive display recording medium which is different from the one used as a reversible thermosensitive recording card as shown in FIGS. 8A and 8B. FIG. 9A shows a reversible displaying surface of the reversible thermosensitive recording card (a front side) and back surface (back side). A film in which the reversible thermosensitive layer and the protective layer disposed on the support is processed into a card-like, and a reversible display part 26 processed in a label is affixed on the front side, and a depression part 25 for accommodating an IC chip is formed on the back side.

FIG. 9B shows an example of a wafer 231 which is an IC chip accommodated in the depression part 25. In FIG. 9B, the wafer 231 in which an integrated circuit 233 is provided on a wafer substrate 232, and a plurality of contacting terminals 234 electrically connected to the integrated circuit 233 are provided on the wafer substrate 232. The contacting terminals 234 are exposed on the back side of the wafer substrate 232 in a configuration that the reader-writer is electrically connected to the contacting terminals 234 and read the information stored in the wafer 231 or write the information in the wafer 231 so as to store it.

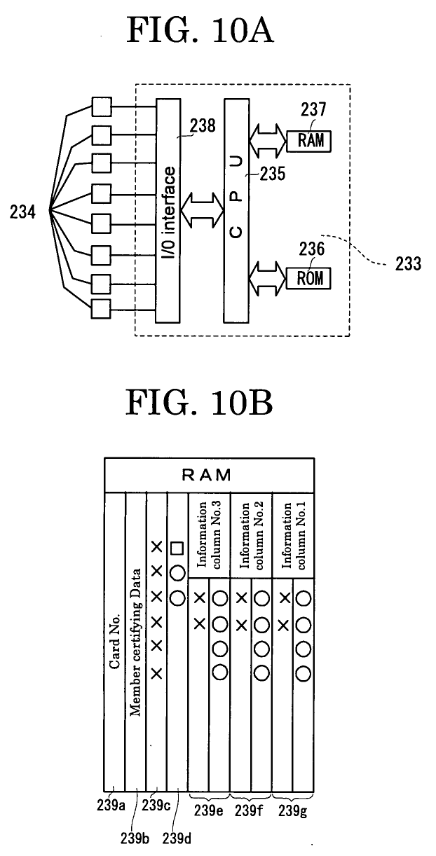

FIGS. 10A and 10B show an example of a block diagram of the integrated circuit 233 and information to be stored. The integrated circuit 233 is comprised of LSI. The integrated circuit 233 contains a CPU 235, a ROM 236, a RAM 237, and an I/O interface 238. The integrated circuit 233 further contains a power-on reset circuit, a clock generating circuit, a pulse divided perimeter circuit, and address decode circuit (not shown).

The CPU 235 is a unit configured to control action by a predetermined procedure. The CPU 235 may perform the action of interrupt control routine depending on the interrupt pulse provided periodically by the pulse divided perimeter circuit. The CPU 235 executes the program data stored in the ROM 236 according to an input signal, and outputs predetermined data in a signal to the reader-writer through the I/O interface 238.

The ROM 236 stores action program data of the CPU235. The RAM 237 is a work memory which writes and reads the data necessary for execution of process.

The I/O interface 238 transmits the input data to the CPU 235 on receiving the input signal, as well as outputs externally on receiving the output signal from the CPU 235. The plural contacting terminals 234 are connected to the I/O interface 238, and the signal of the predetermined data from the reader-writer is input from the contacting terminals 234 through the I/O interface 238 to the CPU 235. The address decode circuit decodes an address data generated by CPU 235, and outputs the signal respectively to the ROM 236, the RAM 237, or the I/O interface 238.

FIG. 10B shows an example of a storage area in the RAM 237 and the information stored therein. In FIG. 10B the RAM 237 contains a plurality of storage areas 239a to 239g. The information or kinds of information stored in each storage area may be determined respectively. For example, a sheet number of the sheet containing the reversible thermosensitive display recording medium is stored in the storage area 239a. For example, in the storage area 239b, the identification information of owner of the sheet such as full name, affiliation, telephone number and the like are stored. For example, in the storage area 239c, the remaining blank in which display record has not been performed in the reversible display part 26, or the information concerning handling of the sheet are stored. For example, the optimal reverse condition of the reversible thermosensitive display recording medium, specifically record condition and erasure condition of the reversible display part 26 are stored in the storage areas 239d to 239g. For example, the record condition is a thermal head control factor, and the erasure condition is an erasing head control factor. The thermal head control factor may have printing speed and pulse shape, and the erasing heat control factor may be the information of erasing time or erasing temperature. The information such as limitation of use environment and suitable use environment may be also stored in the storage area.

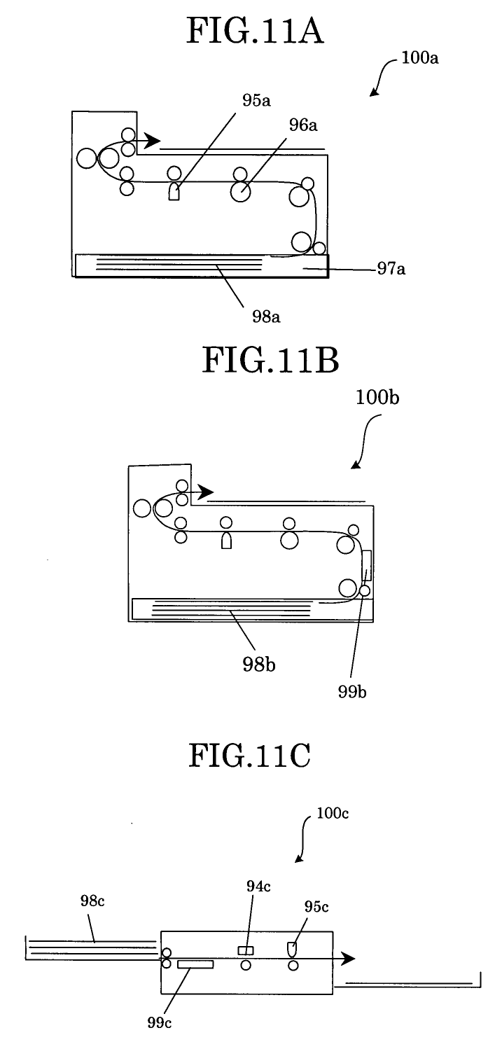

FIGS. 11A to 19 illustrate the image processing apparatus and image processing method of the present invention. In FIGS. 11A to 19, an image forming apparatus is exemplified as the image processing apparatus of the present invention. However, the image processing apparatus of the present invention is not limited to the image forming apparatus, and may be any image processing apparatus as long as it performs display record or display erasure in the reversible display recording medium.

FIGS. 11A to 11C show examples of the image forming apparatuses which form and erase an image by means of the image processing method of the present invention. FIG. 11A shows an example of the image forming apparatus equipped with a thermal head as an image forming unit, and a heat roller as an image erasing unit. As shown in FIG. 11A, in an image forming apparatus 100a, a reversible thermosensitive display recording medium 98a stacked in a paper feeding tray 97a, from which the recording media may be picked up sheet by sheet by a sheet-feeding method, such as a friction pad type, and then conveyed by the conveying roller to a heat roller 96a. The reversible thermosensitive display recording medium 98a is heated by the heat roller 96a under the predetermined condition so as to erase a formed imaged. Then, the reversible thermosensitive display recording medium 98a is conveyed to the thermal head 95a, where an image is newly formed on the reversible thermosensitive display recording medium 98a.

FIG. 11B shows an example of the image forming apparatus which forms and erases an image on the reversible thermosensitive display recording medium having the RF-ID tag. As shown in FIG. 11B, an image forming apparatus 100b contains a reader-writer 99b for the RF-ID tag in addition to the configuration of the image forming apparatus 100a. The reversible thermosensitive display recording medium 98b stacked in a paper feeding tray has the RF-ID tag which is the digital information storage medium. The reversible thermosensitive display recording medium 98b may be picked up sheet by sheet and conveyed by a conveying roller and the like to the reader-writer 99b, and then the condition information concerning the record condition of forming an image and erasure condition of erasing an image which is stored in the RF-ID tag contained in the reversible thermosensitive display recording medium 98b is read.

In the image forming apparatus 100b, according to the read condition information, the formed image is erased by heating the reversible thermosensitive display recording medium 98b by means of the heat roller on the basis of the erasure condition, and an image is newly formed on the reversible thermosensitive display recording medium 98b by means of the thermal head on the basis of the record information.

FIG. 11C shows an example of the image forming apparatus which forms and erases an image on the reversible thermosensitive display recording medium having the RF-ID tag, and has the same function as the one shown in FIG. 11B but the different configuration therefrom. As shown in FIG. 11C, in an image forming apparatus 100c, a reversible thermosensitive display recording medium 98c stacked in a paper feeding tray may be picked up sheet by sheet and conveyed by a conveying roller and the like to a reader-writer 99c, and then the condition information concerning the record condition of forming an image and erasure condition of erasing an image which is stored in the RF-ID tag contained in the reversible thermosensitive display recording medium 98c is read. In the image forming apparatus 100c, according to the read condition information, the formed image is erased by heating the reversible thermosensitive display recording medium 98c by means of a heat roller 94c on the basis of the erasure condition, and an image is newly formed on the reversible thermosensitive display recording medium 98c by means of the thermal head 95c on the basis of the record information.

In FIGS. 11B to 11C, the condition information which is obtained from the RF-ID tag integrated with the reversible thermosensitive display recording medium is exemplified. However, the image forming apparatus of the present invention may have a reading device corresponding to the kinds of digital information storage medium integrated with the reversible display recording medium. For example, a magnetic head is used to obtain information stored in magnetic memories such as a magnetic tape, a magnetic layer and a magnetic stripe, and an optical sensor is used to obtain the information stored in an optical memory. When the reversible display recording medium contains the condition information in a code, the condition information is obtained by a reading device such as a bar code reader corresponding to the code.

When the condition information is a model number or lot number of the reversible display recording medium, the record condition or erasure condition corresponding to the model number or lot number may be obtained from a storage device (not shown) contained in the image forming apparatus. When the image forming apparatus contains a communicating unit configured to communicate through a network, the record condition or erasure condition may be obtained from a server connected though the network to the image forming apparatus, and stored in the storage device (not shown).

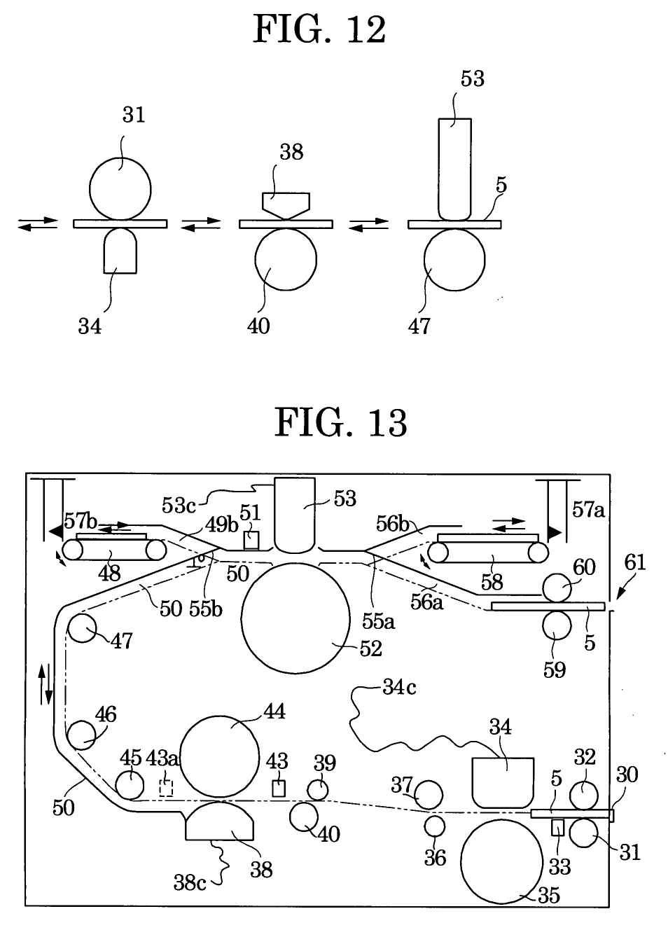

FIG. 12 shows an example of a part of an image processing apparatus in which an image is erased by a ceramic heater, and an image is formed by a thermal head respectively. In FIG. 12, the reversible thermosensitive display recording medium having an integrated magnetic layer is processed. FIG. 12 shows a magnetic head 34, a ceramic heater 38, a thermal head 53, and conveying rollers 31, 40 and 47.

As shown in FIG. 12, in a magnetic head 34 the condition information recorded in the magnetic layer or magnetic thermosensitive layer of the reversible thermosensitive display recording medium is read, the erasure condition is set in the ceramic heater 38 according to the condition information, and the image formed on the reversible thermosensitive layer in the reversible thermosensitive display recording medium is erased. And then, the record condition is set in the thermal head 53, and an image is formed on the reversible thermosensitive recording layer according to the condition information. Finally, the information concerning an image to be formed on the magnetic layer or magnetic thermosensitive layer may be recorded in the magnetic head 34.

As shown in FIG. 12, the reversible thermosensitive layer and the magnetic layer or magnetic thermosensitive layer are disposed on different surfaces of the reversible thermosensitive display recording medium from each other, and the reversible thermosensitive display recording medium is conveyed back and force between the magnetic head 34 and the thermal head 53 by the conveying rollers 31, 40 and 47, and a series of the process is performed.

In FIG. 12, an image processing apparatus, in which the ceramic heater 38 is not equipped, is configured only to form an image, but not to erase an image. Alternatively, an image processing apparatus, in which the thermal head 53 is not equipped, is configured only to ease an image, but not to form an image.

FIG. 13 schematically shows an example of an configuration of the conveying route of the reversible thermosensitive display recording medium in the image forming apparatus of the present invention. In FIG. 13, an image forming apparatus contains a magnetic head 34, a magnetic head controlling unit 34c, a ceramic heater 38, a ceramic heater controlling unit 38c, a thermal head 53, a thermal head controlling unit 53c, platen rollers 35, 44, 52, limit switches 57a, 57b, sensors 33, 43, 43a, 51, guide rollers 32, 36, 39, 60, conveying rollers 31, 37, 40, 45, 46, 47, 59, conveying belts 48, 58, conveying routes 49b, 50, 56a, 56b, changing units of conveying route 55a, 55b, entrance 30, and exit 61.

The reversible thermosensitive display recording medium 5 inserted from the entrance 30 is conveyed along the conveying route 50 where the conveying roller 31 and the guide roller 32 are located, and is processed in the magnetic head 34, the ceramic heater 38, and the thermal head 53, and then discharged from the exit 61. The illustration of the functions of the magnetic head 34, the ceramic heater 38, and the thermal head 53, and the processing to the reversible thermosensitive display recording medium 5 are omitted because they are the same as in FIG. 12. The platen roller is a roller configured to hold the reversible thermosensitive display recording medium 5 in the processing part such as the magnetic head 34 so as to improve print precision. The sensor detects insert and discharge of the reversible thermosensitive display recording medium 5.

Alternatively, the reversible thermosensitive display recording medium 5 is conveyed along the conveying route 56b by switching the changing unit of conveying route 55a and is conveyed backwards by the conveying belt 58 driven by the limit switch 57a which is input by pressing the reversible thermosensitive display recording medium 5, and may be processed again in the thermal head 53. The reversible thermosensitive display recording medium 5 which is processed again in the thermal head 53 is conveyed along the conveying route 49b by switching the changing unit of conveying route 55b and through the limit switch 57b and the conveying belt 48 in the forward direction. Thereafter, the reversible thermosensitive display recording medium 5 is discharged through the exit 61 out of the image forming apparatus by means of the guide roller 60.

Further, a set of the above-noted branched conveying route and changing unit of conveying route may be disposed at the both sides of the ceramic heater 38. In this case, the sensor 43a is preferably disposed between the platen roller 44 and the conveying roller 45.

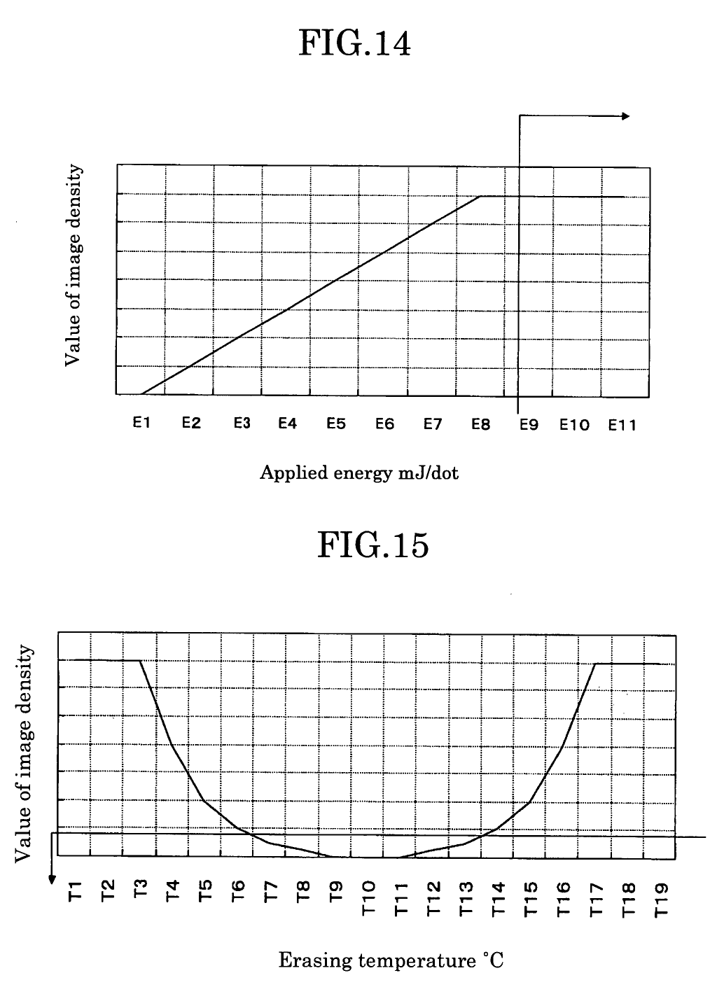

FIG. 14 shows a coloring sensitivity curve of color density property of the reversible thermosensitive display recording medium corresponding to an applied energy. As can be seen from FIG. 14, a stable color density is exhibited when the applied energy is larger than E9. E9 is stored in the digital information storage medium as a record condition, or the record condition is formed in a code on the reversible display recording medium.

FIG. 15 shows an example of an erasing sensitivity curve of image density property of the reversible display recording medium corresponding to an erasing temperature. As can be seen from FIG. 15, an optimum erasing temperature is T10. T10 is stored in the digital information storage medium as an erasure condition, or the record condition is formed in a code on the reversible display recording medium.

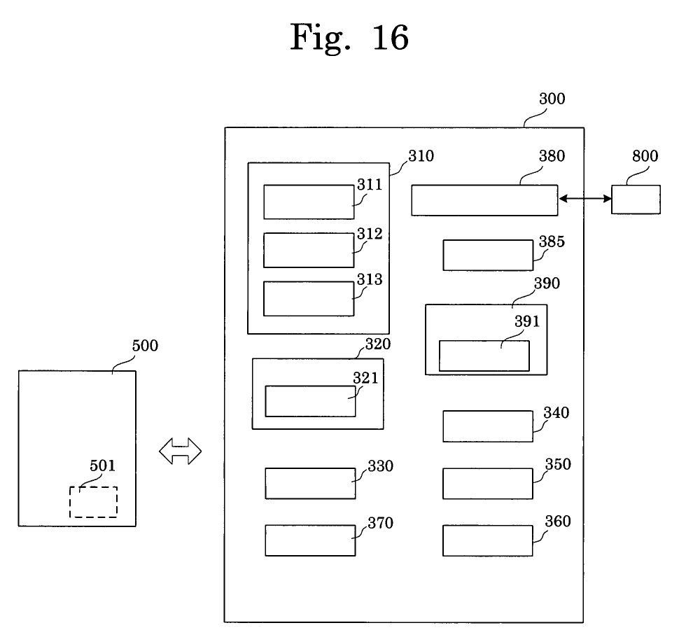

FIG. 16 illustrates an example of a function and configuration of the image forming apparatus of the present invention. In FIG. 16, an image forming apparatus 300 erases or forms an image on a reversible display part in the reversible display recording medium 500 by obtaining the condition information from the reversible display recording medium 500.

The image forming apparatus 300 contains a condition information obtaining unit 310, an image forming unit 320, an image erasing unit 330, a condition information holding unit 340, a condition information encoding unit 350, a condition setting unit 360, an information storage medium writing unit 370, a communicating unit 380, a record or erasure condition obtaining unit 385, and a storing unit 390.

The condition information obtaining unit 310 is a unit configured to obtain the condition information from the reversible display recording medium 500, and contains an information storage medium reading unit 311, a code obtaining unit 312, and a condition information decoding unit 313. The information storage medium reading unit 311 is a unit configured to obtain the condition information by reading the information stored in the digital information storage medium integrated with the reversible display recording medium 500.

The code obtaining unit 312 is a unit configured to obtain a code such as a bar code formed on the reversible display recording medium 500. The code obtaining unit 312 obtains the code depending on a form of the code, a coordinate in which the code is placed, and the like. The condition information decoding unit 313 is a unit configured to obtain the condition information by decoding a code obtained by the code obtaining unit 312.

The information storage medium reading unit 311, the code obtaining unit 312, and the condition information decoding unit 313 are not necessarily provided in the condition information obtaining unit 310, and they may be provided in the condition information obtaining unit 310 as necessary.

The image forming unit 320 is a unit configured to form an image on the reversible display part in the reversible display recording medium 500 on the basis of the record condition set by the condition setting unit 360 according to the condition information. The image forming unit 320 may have a condition information adding unit 321. The condition information adding unit 321 is a unit configured to add the condition information in a code on the reversible display recording medium 500. The condition information adding unit 321 adds the condition information encoded by the condition information encoding unit 350.

The image erasing unit 330 is a unit configured to erase an image formed on the reversible display part in the reversible display recording medium 500 on the basis of the erasure condition set by the condition setting unit 360 according to the condition information.

The condition information holding unit 340 is a unit configured to hold the condition information obtained by the condition information obtaining unit 310. The condition information holding unit 340 may be configured as a RAM or a hard disc drive contained in the image forming apparatus 300. The condition information encoding unit 350 is a unit configured to convert condition information to the code such as a bar code. The code generated by the condition information encoding unit 350 may be a one- or two-dimensional bar code or a dot. The condition setting unit 360 is a unit configured to set a record condition for forming an image or a erasure condition for erasing an image according to the condition information obtained by the condition information obtaining unit 310.

The information storage medium writing unit 370 is a unit configured to write a content of an image which is display-recorded by the image forming unit 320 in the digital information storage medium.

The communicating unit 380 is a unit configured to communicate with a server connected through a network. The communicating unit 380 may communicate with a computer which is connected through a serial bus or a parallel bus to the image forming apparatus 300. A record or erasure condition obtaining unit 385 is a unit configured to obtain record condition or erasure condition from the server and the like with which the communicating unit 380 communicates, and store the obtained record condition or erasure condition in the storing unit 390.

The storing unit 390 is configured to be a storage device in the image forming apparatus 300, and has a record or erasure condition holding unit 391. The storing unit 390 may be configured to be a mass storage device such as a hard disc device. The record or erasure condition holding unit 391 is a unit configured to store record condition or erasure condition corresponding to a model number or lot number of the reversible display recording medium, and store tables of record condition or erasure condition corresponding to a plurality of model numbers or lot numbers of the reversible display recording medium. The condition information obtaining unit 310 obtains the record condition or erasure condition from the record or erasure condition holding unit 391 according to the medium information such as a model number or lot number which is the content of the obtained condition information. The record or erasure condition holding unit 391 may be configured to be a storing unit which is integrated with the condition information holding unit 340.

The image forming apparatus 300 may not necessarily have all units, and may have only necessary units in addition to the condition information obtaining unit 310.

A reversible display recording medium 500 is a display recording medium having the reversible display part, and contains the condition information either in the digital information storage medium integrated therewith or formed in the code. The condition information may be stored in the digital information storage medium, and the content of the image formed on the reversible display part may also be stored therein. The condition information is formed in the code, which may contain an irreversible coloring layer, or may be formed by a reversible display recording method in the reversible display part.

A server 800 connects through the network or directly to the image forming apparatus 300, and holds record condition or erasure condition corresponding to the model number or lot number when the condition information is a model number or lot number of the reversible display recording medium.

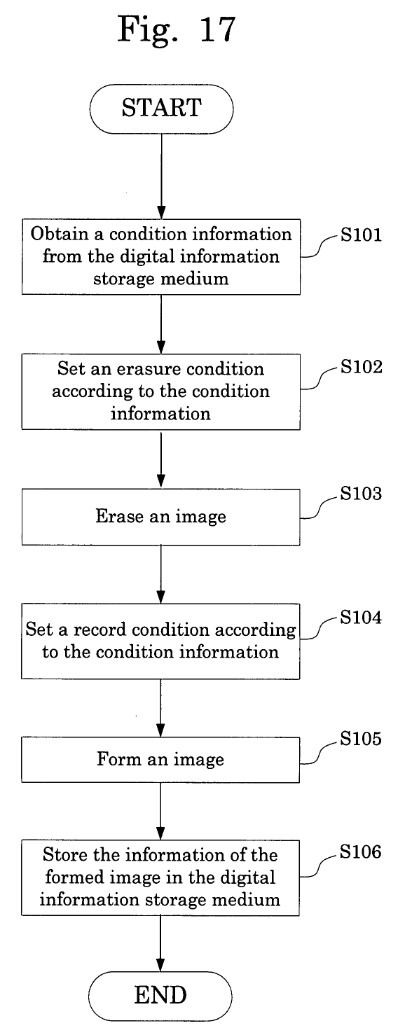

FIG. 17 shows a flow chart of an example of processing of erasing and forming an image according to the condition information obtained from the digital information storage medium of the present invention. In step S101, the information storage medium reading unit 311 obtains the condition information stored in the digital information storage medium integrated with the reversible display recording medium 500. The condition information obtained in step S101 is the record condition and erasure condition.

In step S102, the condition setting unit 360 sets the erasure condition according to the condition information obtained in step S101. In step S103, the image erasing unit 330 erases an image formed on the reversible display surface of the reversible display recording medium 500 on the basis of the erasure condition set in step S102.

In step S104, the condition setting unit 360 sets the record condition according to the condition information obtained in step S101. In step S105 the image forming unit 320 forms an image on the reversible display surface of the reversible display recording medium 500 on the basis of the record condition set in step S104.

In step S106 the information of the image formed in step S104 is stored in the digital information storage medium which is integrated with the reversible display recording medium 500 by the information storage medium writing unit 370.

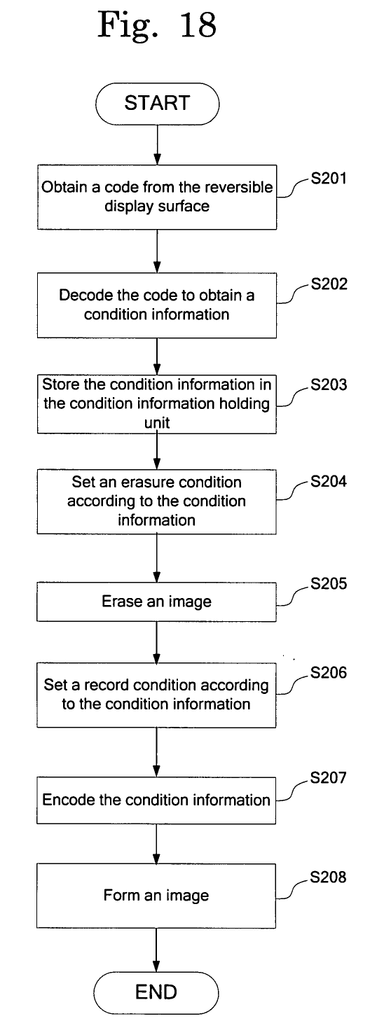

FIG. 18 shows a flow chart of an example of the processing in which the image forming apparatus of the present invention erases and forms an image by obtaining a code formed on the reversible display recording medium of the present invention, and the code of the condition information is reversibly formed on the reversible display surface.

In step S201 the code obtaining unit 312 obtains a code formed on the reversible display surface of the reversible display recording medium 500. For example, the code is a bar code, and obtained from the reversible display recording medium 500 by identifying a predetermined shape or coordinate.

In step S202, the condition information decoding unit 313 decodes the code obtained in step S201 to obtain the condition information. In step S203 the condition information holding unit 340 obtains and holds the condition information decoded in step S202.

In step S204 the condition setting unit 360 sets an erasure condition according to the condition information obtained in step S202. In step S205, the image erasing unit 330 erases the image formed on the reversible display surface of the reversible display recording medium 500 on the basis of the erasure condition set in step S204.

In step S206 the condition setting unit 360 sets a record condition according to the condition information obtained in step S205. In step S207 the condition information encoding unit 350 encodes again the condition information obtained by the condition information holding unit 340 in step S203.

In step S208 the image forming unit 320 forms an image on the reversible display part of the reversible display recording medium 500, the condition information adding unit 321 forms and adds the condition information encoded in step S207 on the reversible display part.

In step S203 the condition information held by the condition information holding unit 340 may be the condition information in a form of a code obtained in step S201 instead of the condition information decoded in step S202. When the condition information holding unit 340 holds the condition information in a form of a code, the processing in step S207 is not performed, and in step S203 the condition information adding unit 321 forms and adds the condition information in a form of a code held by the condition information holding unit 340 on the reversible display part.

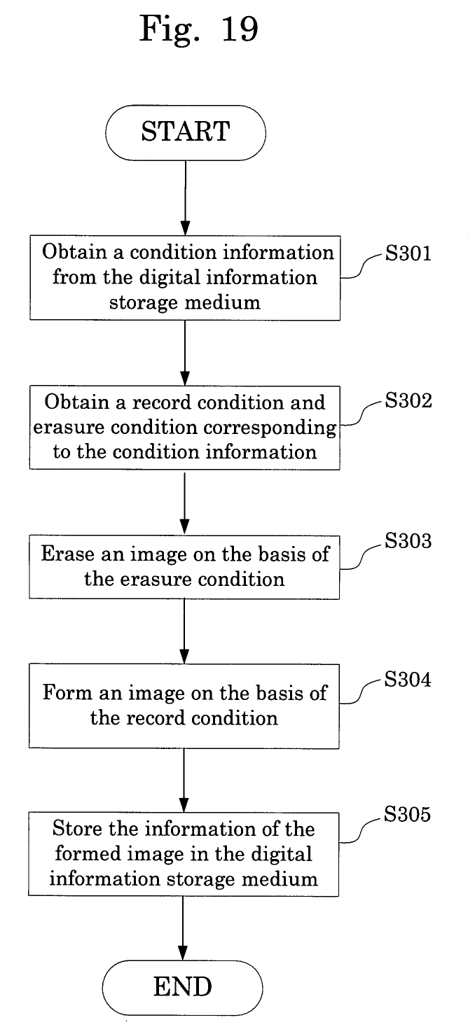

FIG. 19 shows a flow chart of an example of processing of erasing and forming an image by obtaining the record condition and erasure condition according to the condition information obtained from the digital information storage medium. In step S301 the information storage medium reading unit 311 obtains the condition information from the digital information storage medium which is integrated with the reversible display recording medium 500. The condition information obtained in step S301 is a model number or lot number and the like in the reversible display recording medium 500.

In step S302 the condition information obtaining unit 310 obtains the record condition corresponding to the condition information such as the model number or lot number of the reversible display recording medium 500 obtained in step S301 from the record condition and erasure condition held by the record or erasure condition holding unit 391.

In step S303, the condition setting unit 360 sets the erasure condition obtained in step S302, and the image erasing unit 330 erases the image formed on the reversible display surface of the reversible display recording medium 500 on the basis of the set erasure condition.

In step S304, the condition setting unit 360 sets the record condition obtained in step S302, and forms an image on the reversible display surface of the reversible display recording medium 500 on the basis of the set record condition.

In step S305 the information of the image formed in step S304 is stored in the digital information storage medium which is integrated with the reversible display recording medium 500 by the information storage medium writing unit 370.

In step S302 the record condition or erasure condition held by the record or erasure condition holding unit 391 may be timely obtained or updated by the record or erasure condition obtaining unit 385. The recording or erasure condition obtaining unit 385 obtains the record condition or erasure condition by the communicating unit 380 from the external server 800.

The present invention is not limited to these preferred embodiment, and various changes and modifications can be made without departing the scope of the invention.

What is claimed is:

1. An image processing apparatus comprising:
a condition information obtaining unit configured to obtain condition information concerning a record condition or erasure condition of a reversible display recording medium from the reversible display recording medium,
wherein the image processing apparatus forms an image on the reversible display recording medium.

2. The image processing apparatus according to claim 1, further comprising an image forming unit configured to form an image on the reversible display recording medium on the basis of the record condition.

3. The image processing apparatus according to claim 1, further comprising an image erasing unit configured to erase the image formed on the reversible display recording medium on the basis of the erasure condition.

4. The image processing apparatus according to claim 1, wherein the reversible display recording medium comprises a digital information storage medium which is integrated with the reversible display recording medium, and the condition information obtaining unit obtains the condition information from the digital information storage medium.

5. The image processing apparatus according to claim 1, wherein a code of the condition information is formed on the reversible display recording medium, and the condition information obtaining unit comprises:
a code obtaining unit configured to obtain the code of the condition information, and
a condition information decoding unit configured to decode the code of the condition information.

6. The image processing apparatus according to claim 5, further comprising:
a condition information holding unit configured to hold the condition information obtained by the condition information decoding unit, and
a condition information encoding unit configured to encode the condition information.

7. The image processing apparatus according to claim 1, further comprising:
a record or erasure condition holding unit configured to hold the record condition or erasure condition,
wherein the condition information obtaining unit obtains the record condition or erasure condition from the record or erasure condition holding unit according to medium information, when the condition information comprises the medium information corresponding to a model number or lot number of the reversible display recording medium.

8. The image processing apparatus according to claim 7, further comprising:
a communicating unit configured to communicate through a network, and
a record or erasure condition obtaining unit configured to obtain a record condition or erasure condition from a server connected through the network so as to store the record condition or erasure condition in the record or erasure condition holding unit.

9. An image processing method comprising:
a step of obtaining condition information concerning a record condition or erasure condition of a reversible display recording medium from the reversible display recording medium,
wherein the image processing method forms an image on the reversible display recording medium.

10. The image processing method according to claim 9, further comprising a step of forming the image on the reversible display recording medium on the basis of the record condition.

11. The image processing method according to claim 9, further comprising a step of erasing the image formed on the reversible display recording medium on the basis of the erasure condition.

12. The image processing method according to claim 9, wherein the condition information is obtained from a digital information storage medium integrated with the reversible display recording medium in the step of obtaining the condition information.

13. The image processing method according to claim 9, wherein the step of obtaining the condition information comprises:
a step of obtaining a code of the condition information formed on the reversible display recording medium, and
a step of decoding the code of the condition information.

14. The image processing method according to claim 13, further comprising:
a step of holding the condition information obtained in the step of decoding the condition information, and
a step of encoding the condition information.

15. The image processing method according to claim 9, further comprising:
a step of holding the record condition or erasure condition,
wherein the record condition or erasure condition held in the step of holding the record or erasure condition is obtained according to medium information in the step of obtaining the condition information, when the condition information comprises the medium information corresponding to a model number or lot number of the reversible display recording medium.

16. The image processing method according to claim 15, further comprising:
a step of obtaining the record or erasure condition by a communicating unit configured to communicate through a network from a server which is connected through the network,
wherein the record condition or erasure condition obtained in the step of obtaining the record or erasure condition is held in the step of holding the record condition or erasure condition.

17. A reversible display recording medium comprising a digital information storage medium which is integrated with the reversible display recording medium, wherein the reversible display recording medium can display-record and display-erase, and condition information concerning a display record and display erasure is stored in the digital information storage medium.

18. A reversible display recording medium comprising a code of condition information concerning a display record and display erasure, wherein the code comprises an irreversible coloring layer and is formed on the reversible display recording medium which can display-record and display-erase.
